(19) United States
(12) Patent Application Publication
(10) Pub. No.: US 2018/0000194 A1
(43) Pub. Date: Jan. 4, 2018

(54) ANATOMICAL INSOLE FOR FOOTWEAR

(71) Applicant: Marta ESTRADA VIGUERAS, Madrid (ES)

(72) Inventor: Marta ESTRADA VIGUERAS, Madrid (ES)

(21) Appl. No.: 15/485,245

(22) Filed: Apr. 12, 2017

(30) Foreign Application Priority Data
Jul. 1, 2016 (ES) 201630861

(51) Int. Cl. A43B 7/14; A43B 17/14; A43B 17/02; A43B 13/40; B29K 7/00; B29D 35/02; B29D 35/12

(52) U.S. Cl. CPC A43B 7/149; A43B 17/02; A43B 7/142; A43B 7/1425; A43B 17/14; A43B 7/141; A43B 13/40; A43B 7/145; B29D 35/02; B29D 35/12; B29K 2007/00

(57) ABSTRACT

An anatomical insole for footwear which comprises in its entirety a one-piece padded body, wherein it has a thicker padded area in the form of a bubble in the area of the foot arch, a thicker padded area in the form of a bubble in the area which supports the metatarsals of the foot and a thicker padded area in the form of a bubble in the area located between the metatarsals and the toes of the foot.

### RELATED APPLICATION

This application claims the benefit of priority of Spanish Patent Application No. 201630861 filed Jul. 1, 2016, the contents of which are incorporated herein by reference in their entirety.

### FIELD AND BACKGROUND OF THE INVENTION

The invention applies to the field of footwear in general.

Currently known is a wide variety of insoles specifically intended for the footwear sector with the aim of providing greater comfort for the user, said insoles made of different materials, such as latex, rubber, cork, silicone, etc., which are obtained mainly through injection or compression molding.

The aim of this wide range of insoles is to insert them into footwear and ensure that they are as resistant as possible, but focusing on obtaining said qualities without negatively affecting the quality and intended function of the insoles.

It is known that there are different parts of the foot that are subjected to specific impacts or stress caused by walking, especially in shoes with heels, and which therefore require special attention.

Generally, the insoles used for shoes with heels are made up of a thinner layer or strip that is made of a suitable material in order to cover the entire length of the shoe, without focusing on the different parts of the foot, at least not the most vulnerable parts, since these are usually insoles that are fixed during the manufacturing process of the shoe and are therefore not specifically designed to fit the shape of the foot they are intended for.

### SUMMARY OF THE INVENTION

The present invention relates to an anatomical insole for footwear, as described in the title of the present specification.

The main technical problem solved by this invention is that said insole is anatomical thanks to its function of redistributing bodyweight and cushioning steps due to the shape of the same and the material it is made out of. Particularly, said anatomical insole is applied mainly to shoes with heels.

### BRIEF DESCRIPTION OF THE SEVERAL VIEWS OF THE DRAWINGS

In order to assist in a better understanding of the characteristics of the invention according to a practical preferred embodiment thereof and with the aim of complementing this description, the following figures are attached constituting an integral part of the same, which, by way of illustration and non-limitation, represent the following:

FIG. 1 graphically represents a top view of the anatomical insole, object of this invention.

FIG. 2 graphically represents a view from more of a more lateral position of the anatomical insole, object of this invention.

### DESCRIPTION OF SPECIFIC EMBODIMENTS OF THE INVENTION

The elements defined in this detailed description are provided to help achieve a comprehensive understanding of the invention. As a result, a person skilled in the art will recognize that variations and modifications to the embodiments described in this document can be made without deviating from the scope and spirit of the invention. Moreover, a detailed description of the functions and the elements that are sufficiently known has been omitted for reasons of clarity and concision.

The present invention solves the aforementioned technical problem by providing an anatomical insole for shoes (100) which has the function of redistributing bodyweight and cushioning steps, especially in shoes with heels.

Feet are not flat, and therefore when an insole is flat, one will step in an altered and incomplete manner. The arch of the foot and the joints between the phalanges of the toes and the metatarsals form the concave space which flat insoles do not fill. Therefore, the pressure remains localized in the metatarsals and the toes. These empty spaces reduce the amount of support points and create excess tension on the aforementioned bones.

The insole (100), object of this invention, does not only fill in these two spaces, but it also provides cushioning for the metatarsals. The padding of the foot loses elasticity as time goes by due to the impact against the ground. This insole (100) has low-density padding which provides comfort by reducing the hardness of the impact of the foot against the ground.

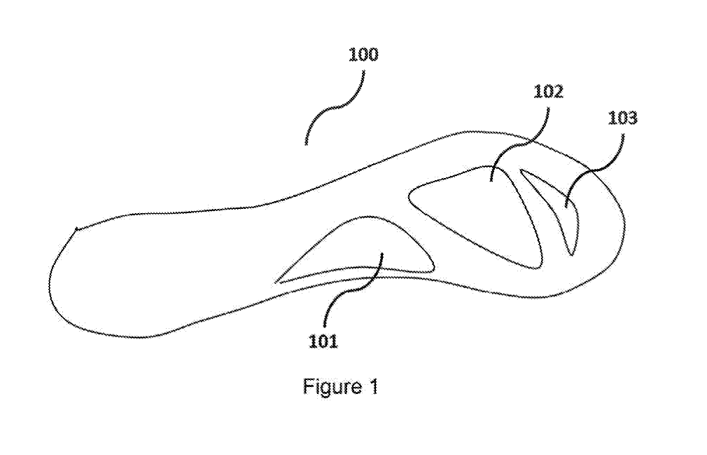

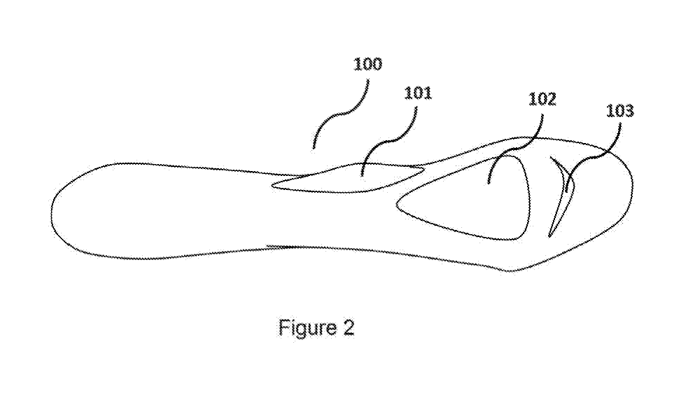

Specifically, according to the images in FIGS. 1 and 2, the insole (100), in addition to the padding at the base, has three areas of thicker padding to provide special protection. The first area (101) has the form of a bubble in the area of the arch of the foot, which allows for a better placement of the same and which therefore provides a greater surface for the distribution of weight. The second area (102), which has more padding, is a bubble in the area of the metatarsals with the aim of reducing the impact against the ground. And the third area (103) is a bubble in the area located in the space between the metatarsals and the toes, which also allows for a better distribution of weight and the support surface, and eases the tension of the nerves in the area.

Preferably, the insole (100) is made up of one single piece or single body and the material of which said insole (100) is made is latex, which has high elasticity, unlike other materials such as gel, which is used for example in some removable insoles, and which does not have the same elasticity, which may cause discomfort. Alternatively, said insole (100) can also be made using polyurethane, which has characteristics similar to those of latex.

In the manufacturing of the insole (100), the polyurethane or latex is placed between two metal plates called molds, and by means of processes of heat application it is molded to the desired form. It is very soft and therefore is easily adaptable. In this way, the variety of shapes of the sole of each shoe does not pose a problem since the insole is very adaptable, especially in shoes with heels.

Although they could be removable insoles (100), according to a preferred embodiment they are incorporated in the shoes themselves and therefore are not visible.

The elements defined in this description are provided to help achieve a comprehensive understanding of the invention. As a result, a person skilled in the art will recognize that variations and modifications to the embodiments described in this document can be made without deviating from the scope and spirit of the invention.

What is claimed is:

1. An anatomical insole for footwear (100) which comprises in its entirety a one-piece padded body, characterized in that it has a thicker padded area in the form of a bubble in the area of the foot arch (101), a thicker padded area in the form of a bubble in the area which supports the metatarsals of the foot (102) and a thicker padded area in the form of a bubble in the area located between the metatarsals and the toes of the foot (103).

2. The anatomical insole for footwear (100) according to claim 1, wherein the material used to manufacture said one-piece body is latex.

3. The anatomical insole for footwear (100) according to claim 1, wherein the material used to manufacture said one-piece body is latex.

4. The anatomical insole for footwear (100), according to claim 2, wherein said one-piece body is manufactured by introducing said manufacturing material between a mold formed by two plates to which heat is applied so that said material takes the form of said one-piece body.

5. The anatomical insole for footwear (100), according to claim 1, wherein said insole (100) is specific for shoes with heels.

6. The anatomical insole for footwear (100), according to claim 1, wherein said insole (100) is adhered to the shoe.

7. The anatomical insole for footwear (100), according to claim 3, wherein said one-piece body is manufactured by introducing said manufacturing material between a mold formed by two plates to which heat is applied so that said material takes the form of said one-piece body.
